(19) United States
(12) Patent Application Publication
(10) Pub. No.: US 2007/0246856 A1
(43) Pub. Date: Oct. 25, 2007

(54) Optical element forming apparatus and method

(75) Inventor: Nobuhiro Yamamichi, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/730,203

(22) Filed: Mar. 30, 2007

(30) Foreign Application Priority Data
Apr. 25, 2006 (JP) 2006-120183

(51) Int. Cl. B29C 33/40

(52) U.S. Cl. 264/219

(57) ABSTRACT

A forming apparatus for an optical element includes a first forming die having a forming convex portion, a second forming die having a forming concave portion, a forming die driving mechanism, and an optical-element-material holding mechanism. The forming convex portion is adapted to cave a side of a first principal surface of an optical element material; and adapted to protrude a side of a second principal surface of the optical element material. The forming concave portion is adapted to form the side of the second principal surface by sandwiching the optical element material between the forming convex portion and the forming concave portion. The forming die driving mechanism is adapted to move the first forming die and the second forming die in directions away from and toward each other. The optical-element-material holding mechanism is adapted to hold a peripheral portion of the optical element material so as to enable the first forming die to deform the optical element material by pressure, while maintaining the optical element material under a noncontact state with the second forming die.

### CROSS REFERENCES TO RELATED APPLICATIONS

The present invention contains subject matter related to Japanese Patent Application JP 2006-120183 filed in the Japanese Patent Office on Apr. 25, 2006, the entire contents of which being incorporated herein by reference.

### BACKGROUND OF THE INVENTION

The present invention relates to forming apparatus and method for an optical element, in which the optical element such as a meniscus lens is formed by press-forming from a material such as glass or plastic.

The meniscus lens is a lens including a concave surface defining one-side surface and a convex surface defining another-side (opposite) surface. The meniscus lens can be classified broadly into a convex meniscus lens and a concave meniscus lens in categories. The convex meniscus lens is a lens having a radially outer portion thinner than its center portion within a range of optical effective area. Namely in the convex meniscus lens, its convex surface has a curvature radius smaller than a curvature radius of its concave surface. On the other hand, the concave meniscus lens is a lens having a radially outer portion thicker than its center portion within a range of the optical effective area. Namely in the concave meniscus lens, its convex surface has a curvature radius larger than a curvature radius of its concave surface. The meniscus lens is used as, for example, a lens of an optical lens barrel functioning as a so-called optical-axis bending system using a prism, inside a card-type digital camera and the like. In particular, an aspherical concave meniscus lens attracts attentions as a much-in-demand and important lens, since the aspherical concave meniscus lens can simplify a structure of the optical lens barrel.

With respect to the forming (manufacturing) of the meniscus lens, there are a method based on grinding and polishing and a method in which the material such as glass or plastic is molded by press molding. The manufacturing method based on the press molding is now brought to attention with the progress toward aspherizing the meniscus lens (i.e., toward designing the meniscus lens to be aspherical). As the method of manufacturing the meniscus lens by press molding; there are a method in which a material preformed in a shape of grain (shape of ball) that is called “preform material” is heated and deformed to the meniscus lens by imposing a press working, and a method in which a material preformed in a shape of plate is heated and deformed to the meniscus lens by imposing a press working. (see, e.g., Japanese Patent published Application No. H06(1994)-9228, Japanese Patent published Application No. H09(1997)-295817, and Japanese Patent published Application No. 2002-249327)

The method in which the grain-shaped (ball-shaped) preform material is used has a problem that the grain-shaped preform material needs to be deformed in many steps and the press working takes a long time. This is because a deformation degree (amount) for deforming the grain-shaped preform material into the meniscus lens is high.

The method in which the plate-shaped preform material is used has an advantage that the deformation degree for deforming the plate-shaped preform material into the meniscus lens is low as compared with the case where the grain-shaped preform material is used, and thereby the time necessary for the press working can be shortened. This is because the meniscus lens is formed by curving the plate-shaped preform material. On the other hand, when the plate-shaped preform material 101 is placed on a substantially-spherical concave portion 103 of an upper end of a lower die 102 as shown in FIG. 13; a lower end peripheral portion 101a of plate-shaped preform material 101 becomes in contact with the substantially-spherical concave portion 103 so that a space 104 is produced on the lower surface side of plate-shaped preform material 101. Inside the space 104, a gas charged in a molding chamber (room) such as nitrogen gas is enclosed. Under this state, when the plate-shaped preform material 101 is deformed by a substantially-spherical convex portion 106 of a lower end of an upper die 105 by moving down the upper die 105 as shown in FIG. 14, the enclosed gas causes a recess (concave) portion 112 in a lower surface side of the meniscus lens 111 as a product as shown in FIG. 15. Thereby, there is a problem that a product's value of meniscus lens is affected.

To solve the problem of enclosing the gas, one forming apparatus is being developed in which the press for the plate-shaped preform material is carried out under vacuum. Moreover, another forming apparatus is being developed in which the enclosed gas 121 is discharged through a vent (gas escape hole) 122 to the outside as shown in FIG. 16. (see Japanese Patent published Application No. H03(1991)-131537)

### SUMMARY OF THE INVENTION

However, in the case where the forming apparatus in which the press for the plate-shaped preform material is carried out under vacuum is employed, there has been a problem that a vacuum unit and the like are necessary and thereby (a system of) the apparatus is complicated with an increase in cost. Moreover, in the case where the forming apparatus in which the enclosed gas is discharged through the vent to the outside is employed, there has been a problem that the optical material such as a glass enters the vent 122 and thereby a projection 124 is formed in the optical element 123 such as lens, as shown in FIG. 17.

It is better to free the projection 124 even if the projection 124 does not largely reduce an optical property of optical element 123 such as lens. Hence, in the forming apparatus or forming method for this kind of optical element, it has been recognized as an important issue to prevent the enclosure (containment) of the gas more reliably in a more simple way without forming the above-mentioned projection.

Accordingly, it is desirable to provide forming apparatus and forming method, devised not to need a complex unit such as the vacuum unit, and to prevent the enclosure of the gas even in the case where the optical element is formed within the gas such as inert gas (e.g., nitrogen gas) and thereby to suppress the occurrence of defective (low-quality) products due to the gas enclosure.

According to an embodiment of the present invention, there is provided a forming apparatus for an optical element, including: a first forming die including a forming convex portion having a substantially-spherical surface, the forming convex portion being adapted to cave a side of a first principal surface of an optical element material which has been heated and softened, in the form of a substantially-spherical surface, and adapted to protrude a side of a second principal surface of the optical element material which is located opposite to the first principal surface, in the form of a substantially-spherical surface; a second forming die including a forming concave portion having a substantially-spherical surface, the forming concave portion being adapted to form the side of the second principal surface of the optical element material by sandwiching the optical element material between the forming convex portion of the first forming die and the forming concave portion of the second forming die; a forming die driving mechanism adapted to move the first forming die and the second forming die in a direction away from each other and a direction toward each other; and an optical-element-material holding mechanism adapted to hold a peripheral portion of the optical element material between the first forming die and the second forming die so as to enable the first forming die to deform the optical element material by pressure, while maintaining the optical element material under a noncontact state with the second forming die.

According to another embodiment of the present invention, there is provided a forming method for an optical element, including the steps of: heating and softening an optical element material; caving a first principal surface of an optical element material by pressing a substantially-spherical forming convex portion of a first forming die to the first principal surface of the optical element material while maintaining the optical element material under a noncontact state with a substantially-spherical forming concave portion of a second forming die, and at the same time, protruding a side of a second principal surface of the optical element material which is located opposite to the first principal surface, in the form of a substantially-spherical surface; placing a top portion of the protruded portion located in the side of second principal surface of the optical element material on a center portion of the substantially-spherical forming concave portion of the second forming die; and deforming the first principal surface of the optical element material along the substantially-spherical surface of the forming convex portion of the first forming die, by compressing the optical element material between the forming convex portion of the first forming die and the forming concave portion of the second forming die, and at the same time, deforming the second principal surface of the optical element material along the substantially-spherical surface of the forming concave portion of the second forming die.

### BRIEF DESCRIPTION OF THE DRAWINGS

FIG. 1 is a schematic sectional view showing a forming process of an optical element.

FIG. 2 is a schematic sectional view showing the forming process of the optical element.

FIG. 3 is a schematic sectional view showing the forming process of the optical element.

FIG. 4 is a schematic sectional view showing the forming process of the optical element.

FIG. 5 is a schematic sectional view showing the forming process of the optical element.

FIG. 6 is an oblique perspective view of an optical-element-material holding mechanism.

FIG. 7 is an oblique perspective view of the formed optical element.

FIG. 8 is a flowchart showing the forming process of the optical element.

FIG. 9 is a schematic sectional view showing a forming process of an optical element according to the other embodiment.

FIG. 10 is a schematic sectional view showing the forming process of the optical element according to the other embodiment.

FIG. 11 is a schematic sectional view showing the forming process of the optical element according to the other embodiment.

FIG. 12 is a sectional view showing a comparative example to the forming process according to the present invention.

FIG. 13 is a schematic sectional view showing a forming process of an optical element in a related art.

FIG. 14 is a schematic sectional view showing the forming process of the optical element in the related art.

FIG. 15 is a sectional view showing a problem associated with an optical element formed by the forming process of the related art.

FIG. 16 is a sectional view of the other related art.

FIG. 17 is a sectional view showing a problem of the other related art.

### DETAILED DESCRIPTION OF THE INVENTION

Forming apparatus and method for an optical element according to embodiments of the present invention will be explained below. FIGS. 1 to 5 are schematic sectional views showing a process of forming the optical element in the forming apparatus for an optical element (hereinafter, simply referred to as the forming apparatus 1). The forming apparatus 1 includes a first forming die 3, a second forming die 4, and a forming die driving mechanism 5. The first forming die 3 includes a forming convex portion 3a having a substantially-spherical surface (which has a substantially circular arc in cross section). The forming convex portion 3a serves to cave (make a dent on) a side of one surface 2a (hereinafter, referred to as the first principal surface) of an optical element material 2 heated and softened by a heating means (not shown), to cause the first principal surface 2a to become a substantially-spherical surface (which has a substantially circular arc in cross section). The forming convex portion 3a also serves to protrude a side of another surface 2b (hereinafter, referred to as the second principal surface) located on the opposite side to the first principal surface 2a, to cause the second principal surface 2b to become a substantially-spherical surface (which has a substantially circular arc in cross section). The second forming die 4 includes a forming concave portion 4a having a substantially-spherical surface (having a substantially circular arc in cross section). The forming concave portion 4a serves to form the side of second principal surface 2b of the optical element material 2 in the shape of substantially-spherical surface, by sandwiching and compressing the optical element material 2 between the forming concave portion 4a and the forming convex portion 3a of first forming die 3. The forming die driving mechanism 5 serves to move the first forming die 3 and the second forming die 4 in a direction away from each other and a direction toward each other. The forming apparatus 1 is operated within a gas such as inert gas (e.g., nitrogen gas), when forming the optical element.

Between the first forming die 3 and the second forming die 4, an optical-element-material holding mechanism 6 is provided. The optical-element-material holding mechanism 6 serves to hold a peripheral portion (i.e., outer edge portion) of optical element material 2, so as to enable the first forming die 3 to deform the optical element material 2 by pressure, while maintaining the optical element material 2 under a noncontact state with the second forming die 4 (i.e., under the condition where the optical element material 2 is kept not in contact with the second forming die 4).

The optical element material 2 is formed in the shape of a circular flat plate; and is made of an optical glass having a characteristic in which a glass-transition-point temperature is 550° C., and a yield point is 588° C.

The first forming die 3 is used for forming a concave surface 2c (see FIG. 7) having a predetermined curvature radius in the first principal surface 2a's side of optical element material 2. At a lower end portion of first forming die 3, the first forming die 3 includes the forming convex portion 3a which has a curved surface having the arc shape in cross section.

The second forming die 4 is used for forming a convex surface 2d (see FIG. 7) having a predetermined curvature radius in the second principal surface 2b's side of optical element material 2. At an upper end portion of second forming die 4, the second forming die 4 includes the forming concave portion 4a which has a curved surface having the arc shape in cross section.

A curvature radius of the forming convex portion 3a is formed or designed to be smaller than a curvature radius of the forming concave portion 4a.

The forming die driving mechanism 5 includes a first driving section 5a, and a second driving section 5b. The first driving section 5a is adapted to move up and down the first forming die 3 relative to the second forming die 4, and the second driving section 5b is adapted to move up and down the second forming die 4 relative to the first forming die 3.

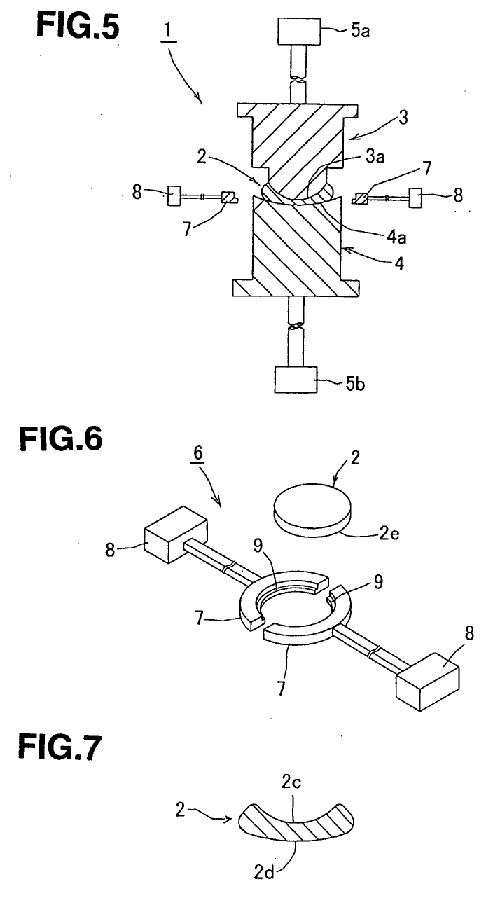

The optical-element-material holding mechanism 6 includes a plurality of optical-element-material supporting frames 7, and a frame driving mechanism 8. The optical-element-material supporting frame(s) 7 serves to support the peripheral portion of optical element material 2 which is radially outside of a lens effective area. The frame driving mechanism 8 moves the plurality of optical-element-material supporting frames 7 between an optical-element-material supporting position shown in FIGS. 1 to 3 and an optical-element-material support-releasing position shown in FIGS. 4 and 5.

As shown in FIG. 6, each of these optical-element-material supporting frames 7 is formed in the shape of a half circle as defined by dividing a circular ring to halves. When the plurality of optical-element-material supporting frames 7 are moved to the optical-element-material supporting position shown in FIGS. 1 to 3 by the frame driving mechanism 8; these optical-element-material supporting frames 7 become substantially shaped like a ring, and support the optical element material 2 by fitting a lower end portion 2e of a radially outer side of optical element material 2 into optical-element-material receiving portions 9 provided in radially inner portions of optical-element-material supporting frames 7 shaped like the ring. Namely, each of optical-element-material supporting frames 7 is formed with the optical-element-material receiving portion 9 at its lower and radially inner portion.

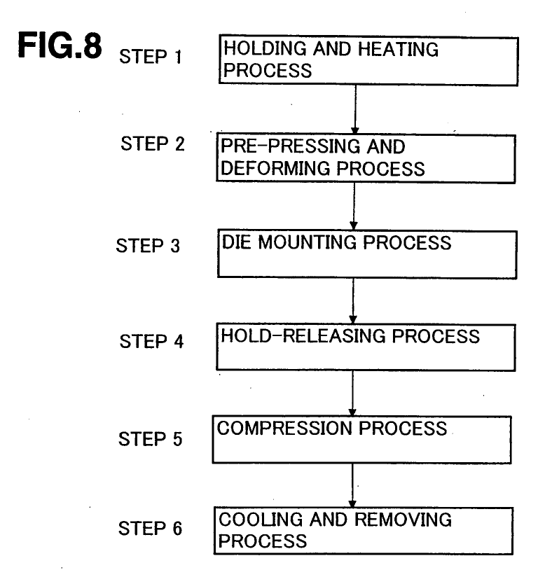

Next, one example of the method of forming the optical element by using the forming apparatus 1 will now be explained referring to a flowchart of FIG. 8.

In a holding and heating process at step 1 as shown in FIG. 1, the optical-element-material holding mechanism 6 disposed between the first forming die 3 and the second forming die 4 holds the optical element material 2. Then, the heating means (not shown) heats and softens the optical element material 2. When the temperature reaches a predetermined value at which a viscosity of optical element material 2 becomes between Log η=9 and Log η=10; this condition is kept for a given time period (e.g., for 60 seconds), namely until a temperature of an inner portion of optical element material 2 becomes constant.

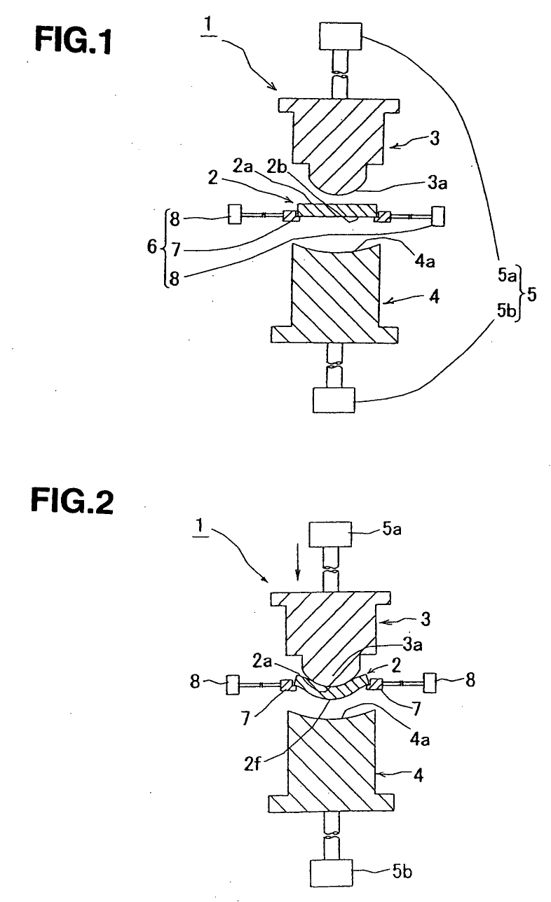

In a pre-pressing and deforming process at step 2 as shown in FIG. 2, the first driving section 5a moves down the first forming die 3, and brings the forming convex portion 3a to the first principal surface 2a of optical element material 2. Then, the first driving section 5a slowly lowers the forming convex portion 3a, and thereby caves the first principal surface 2a of optical element material 2 and protrudes the side of second principal surface 2b in the form of substantially-spherical surface (curved surface having the arc shape in cross section). A curvature radius of this protruding portion (thus-protruded second principal surface 2b) becomes substantially same as the curvature radius of forming convex portion 3a of the first forming die 3, and smaller than the curvature radius of forming concave portion 4a of the second forming die 4.

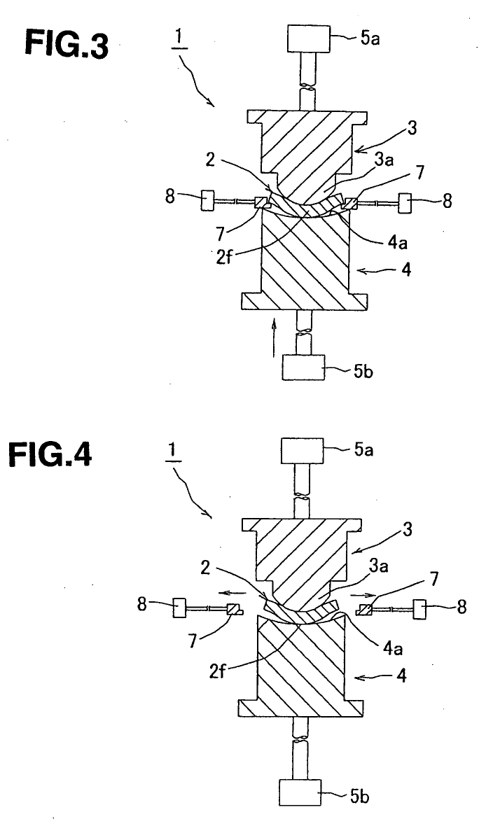

In a die mounting (placing) process at step 3 as shown in FIG. 3, the second driving section 5b moves or places upwardly the second forming die 4 so that a top portion 2f of the protruding portion in the side of second principal surface 2b of optical element material 2 becomes in contact with a center portion of the substantially-spherical forming concave portion 4a of the second forming die 4.

In a hold-releasing process at step 4 as shown in FIG. 4, the frame driving mechanism 8 moves the optical-element-material supporting frames 7 to the optical-element-material support-releasing position, and thereby releases the restraint applied to the optical element material 2 by the optical-element-material supporting frames 7

In a compressing process at step 5 as shown in FIG. 5, the second driving section 5b moves upwardly the second forming die 4, and thereby compresses the optical element material 2 between the forming convex portion 3a of first forming die 3 and the forming concave portion 4a of second forming die 4. During this compression, the second principal surface 2b of optical element material 2 is pressed to the forming concave portion 4a of second forming die 4. Namely, a peripheral portion around the top portion 2f of second principal surface 2b is gradually pressed to the forming concave portion 4a. At the same time, the side of first principal surface 2a of the optical element material 2 is pressed to the forming convex portion 3a of first forming die 3. Then, the first principal surface 2a of optical element material 2 is deformed along the substantially-spherical surface of the forming convex portion 3a of first forming die 3, and the second principal surface 2b of optical element material 2 is deformed along the substantially-spherical surface of the forming concave portion 4a of second forming die 4.

In a cooling and removing process at step 6, the optical element material 2 compressed and deformed between the forming convex portion 3a of first forming die 3 and the forming concave portion 4a of second forming die 4 is cooled by a cooling mechanism (not shown) up to a predetermined temperature, e.g., 200° C. Then, the product 2 is removed by moving or opening the first forming die 3 and the second forming die 4. As shown in FIG. 7, a concave meniscus lens (product 2) in which the curvature radius of concave surface 2c on the side of first principal surface 2a is smaller than the curvature radius of convex surface 2d on the side of second principal surface 2b is manufactured from the plate-shaped optical element material 2.

In the case where the concave meniscus lens is formed, the curvature radius of the forming concave portion 4a having the substantially-spherical surface (arc-shaped surface) is made (designed) to be larger than the curvature radius of forming convex portion 3a having the substantially-spherical surface (arc-shaped surface). Hence, when the first principal surface 2a of optical element material 2 is caved and also the side of second principal surface 2b is made to protrude in the form of substantially-spherical surface, by pressing the forming convex portion 3a of first forming die 3 against the first principal surface 2a of optical element material 2 and by lowering the forming convex portion 3a as shown in FIG. 2; the curvature radius of this protruding portion becomes substantially same as the curvature radius of forming convex portion 3a of the first forming die 3, and smaller than the curvature radius of forming concave portion 4a of the second forming die 4. Therefore as shown in FIG. 3, it is prevented to produce a gas storing space (gas hole) in a center portion of the lower surface of optical element material 2 since the top portion 2f of the protruding portion in the side of second principal surface 2b of the optical element material 2 becomes in contact with the forming concave portion 4a of second forming die 4. When the second driving section 5b is raising the second forming die 4; the second principal surface 2b of optical element material 2 is pressed to the forming concave portion 4a of second forming die 4 so as to cause the peripheral side around top portion 2f to be pressed to the forming concave portion 4a having the substantially-spherical surface, sequentially from the top portion 2f as mentioned above, while eliminating or removing a gas existing around the top portion 2f. Namely, the forming concave portion 4a is forced to become in contact with from the top portion 2f gradually toward the second principal surface 2b's radially outer portion around the top portion 2f. Finally, the gas existing on the side of second principal surface 2b is completely eliminated to the outside, and accordingly it is reliably prevented to contain the gas.

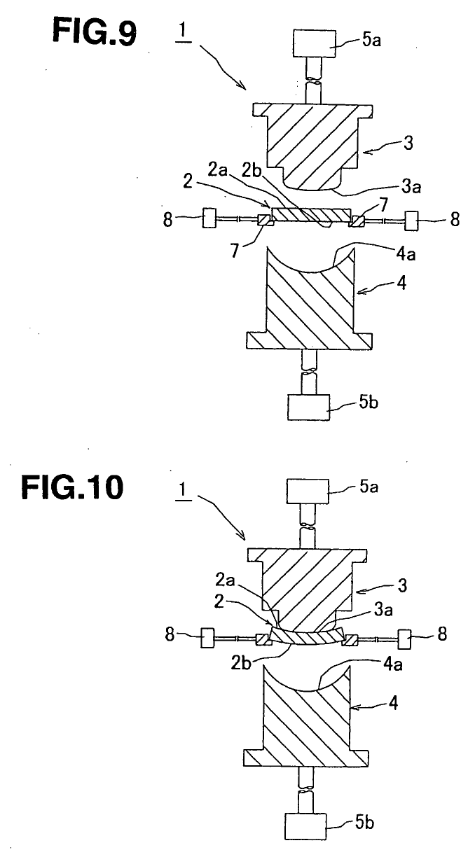

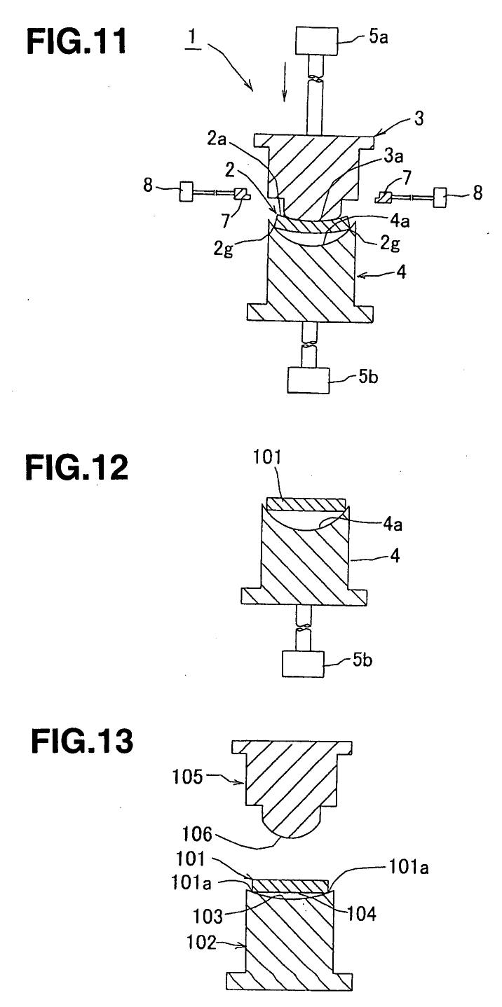

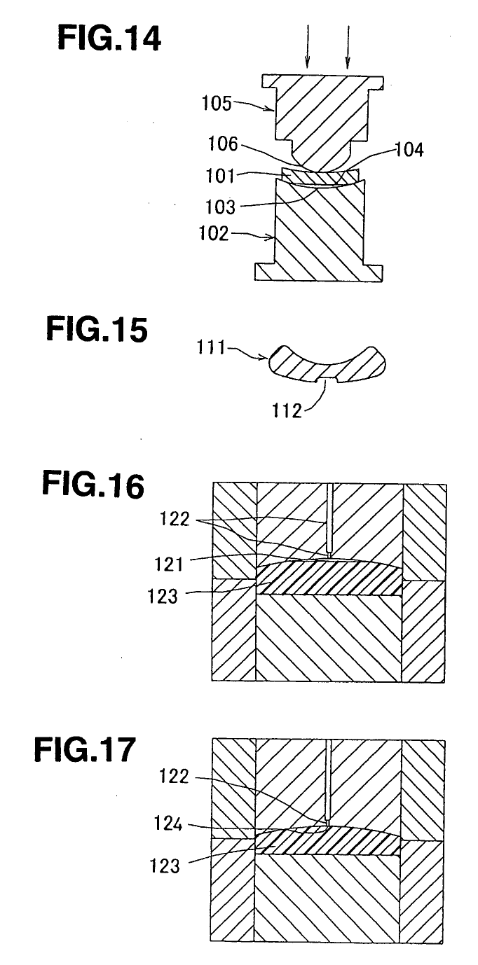

In the case where a convex meniscus lens is formed, contrary to the case where the concave meniscus lens is formed; the curvature radius of the forming concave portion 4a having the substantially-spherical surface is made (designed) to be smaller than the curvature radius of the forming convex portion 3a having the substantially-spherical surface as shown in FIG. 9. Hence, when the first principal surface 2a of optical element material 2 is caved and also the side of second principal surface 2b is made to protrude in the form of substantially-spherical surface, by pressing the forming convex portion 3a of first forming die 3 against the first principal surface 2a of optical element material 2 and by lowering the forming convex portion 3a as shown in FIG. 10; the curvature radius of this protruding portion becomes substantially same as the curvature radius of forming convex portion 3a of the first forming die 3, and larger than the curvature radius of forming concave portion 4a of the second forming die 4. Therefore as shown in FIG. 11, an outer peripheral portion (outer edge portion) 2g of the protruding portion in the side of second principal surface 2b of the optical element material 2 becomes in contact with the forming concave portion 4a of second forming die 4, and thereby a gas is enclosed on the side of lower surface of the optical element material 2. However, a radially inner side more than the contact portion (outer peripheral portion 2g) enters the forming concave portion 4a of second forming die 4 since the protruding portion in the side of second principal surface 2b of the optical element material 2 is formed to have the substantially-spherical (arc-shaped) surface. Hence, the volume of a gas storing space inside the forming concave portion 4a can be reduced as compared with a flat-plate-shaped optical element material 101 shown in FIG. 12 as a comparative example. Therefore, an adverse effect which is caused due to the enclosed gas can be minimized.

In the above-described embodiments, the case where the glass is employed as the optical element material 2 is exemplified. However, an optical plastic, for example ZEONEX (registered trademark) made by ZEON corporation or acrylic resin may be employed as the optical element material 2. Moreover in the above-described embodiments, the optical-element-material holding mechanism 6 includes the plurality of arc-shaped optical-element-material supporting frames 7 for supporting the peripheral portion of optical element material 2 radially outside the lens effective area. However, the optical-element-material holding mechanism 6 may be constructed to hold the optical element material 2 under a floating state by blowing a compressed gas or the like toward the optical element material 2. Furthermore, the substantially-spherical (arc-shaped) surface mentioned in the above embodiments means not only a spherical surface but also an aspherical surface. Furthermore in the above-described embodiments, the concave surface and the convex surface of the optical element are made in the form of spherical surface. However, both of the concave surface and the convex surface of the optical element may be made in the form of aspherical surface, or the concave surface and the convex surface of the optical element may be constructed in such a manner that one of the concave surface and the convex surface is made in the form of spherical surface and another of the concave surface and the convex surface is made in the form of aspherical surface.

It should be understood by those skilled in the art that various modifications, combinations, sub-combinations and alterations may occur depending on design requirements and other factors insofar as they are within the scope of the appended claims or the equivalents thereof.

What is claimed is:

1. A forming apparatus for an optical element, comprising:
a first forming die including
a forming convex portion having a substantially-spherical surface, the forming convex portion being
adapted to cave a side of a first principal surface of an optical element material which has been heated and softened, in the form of a substantially-spherical surface, and
adapted to protrude a side of a second principal surface of the optical element material which is located opposite to the first principal surface, in the form of a substantially-spherical surface;
a second forming die including
a forming concave portion having a substantially-spherical surface, the forming concave portion being adapted to form the side of the second principal surface of the optical element material by sandwiching the optical element material between the forming convex portion of the first forming die and the forming concave portion of the second forming die;
a forming die driving mechanism adapted to move the first forming die and the second forming die in a direction away from each other and a direction toward each other; and
an optical-element-material holding mechanism adapted to hold a peripheral portion of the optical element material between the first forming die and the second forming die so as to enable the first forming die to deform the optical element material by pressure, while maintaining the optical element material under a noncontact state with the second forming die.

2. The forming apparatus as claimed in claim 1, wherein
the optical-element-material holding mechanism includes
a plurality of optical-element-material supporting frames adapted to support the peripheral portion of the optical element material which is outside of a lens effective area, and
a frame driving mechanism adapted to move the plurality of optical-element-material supporting frames between an optical-element-material supporting position and an optical-element-material support-releasing position.

3. The forming apparatus as claimed in claim 1, wherein
a curvature radius of the substantially-spherical forming convex portion of the first forming die is formed to be smaller than a curvature radius of the substantially-spherical forming concave portion of the second forming die.

4. A forming method for an optical element, comprising the steps of:
heating and softening an optical element material;
caving a first principal surface of an optical element material by pressing a substantially-spherical forming convex portion of a first forming die to the first principal surface of the optical element material while maintaining the optical element material under a noncontact state with a substantially-spherical forming concave portion of a second forming die, and
at the same time, protruding a side of a second principal surface of the optical element material which is located opposite to the first principal surface, in the form of a substantially-spherical surface;
placing a top portion of the protruded portion located in the side of second principal surface of the optical element material on a center portion of the substantially-spherical forming concave portion of the second forming die; and
deforming the first principal surface of the optical element material along the substantially-spherical surface of the forming convex portion of the first forming die, by compressing the optical element material between the forming convex portion of the first forming die and the forming concave portion of the second forming die, and
at the same time, deforming the second principal surface of the optical element material along the substantially-spherical surface of the forming concave portion of the second forming die.

5. The forming method as claimed in claim 4, wherein
a concave-surface curvature radius of the first principal surface of the optical element material compressed and deformed by the substantially-spherical forming convex portion of the first forming die is formed to be smaller than a convex-surface curvature radius of the second principal surface of the optical element material.

6. The forming method as claimed in claim 4, wherein in the deforming step,
the forming convex portion of the first forming die presses the optical element material of which the top portion located in the side of second principal surface has been placed on the center portion of the substantially-spherical forming concave portion of the second forming die, so as to cause a peripheral portion around the top portion located in the side of second principal surface to be pressed to the substantially-spherical forming concave portion of the second forming die, gradually from the top portion.

7. The forming method as claimed in claim 4, wherein in the heating and softening step,
the optical element material to be heated and softened is in the form of a flat plate.

8. The forming method as claimed in claim 4, wherein
the optical element material is heated and softened under the condition where the optical element material is held by an optical-element-material holding mechanism; and
the substantially-spherical forming convex portion of the first forming die is pressed to the first principal surface of the optical element material, while the optical-element-material holding mechanism maintains the optical element material under the noncontact state with the substantially-spherical forming concave portion of the second forming die.

9. The forming method as claimed in claim 4, wherein the optical element material is made of a glass.

10. The forming method as claimed in claim 4, wherein the optical element material is made of a plastic.
